(19) United States
(12) Patent Application Publication
(10) Pub. No.: US 2013/0212502 A1
(43) Pub. Date: Aug. 15, 2013

(54) APPARATUS AND METHOD FOR DISPLAYING CONTENT AND ATTRIBUTE INFORMATION

(71) Applicant: PANTECH CO., LTD., (US)

(72) Inventors: Hyoung Sik AHN, Seoul (KR); Eun Sook Park, Seoul (KR); Myung Seob Oh, Seoul (KR)

(73) Assignee: PANTECH CO., LTD., Seoul (KR)

(21) Appl. No.: 13/731,609

(22) Filed: Dec. 31, 2012

(30) Foreign Application Priority Data
Feb. 15, 2012 (KR) 10-2012-0015258

(51) Int. Cl. G06F 3/048

(52) U.S. Cl. CPC G06F 3/048
USPC 715/764

(57) ABSTRACT

A method for displaying attribute information of data includes receiving a request for the data, determining whether one or more pieces of attribute information are included in the data, processing a piece of attribute information if it is determined that at least one piece of attribute information is included in the data, and displaying the processed piece of attribute information. A content displays apparatus includes a data request receiver to receive a request to receive data, an attribute information detector to detect one or more pieces of attribute information included in the data, an attribute information processor to process a piece of the detected attribute information, and a display unit to display the processed piece of attribute information.

### CROSS-REFERENCE TO RELATED APPLICATION

This application claims priority from and the benefit under 35 U.S.C. §119(a) of Korean Patent Application No. 10-2012-0015258, filed on Feb. 15, 2012, the entire disclosure of which is incorporated herein by reference for all purposes.

### BACKGROUND

1. Field

The present disclosure relates to an apparatus and a method for providing content and associated attribute information.

2. Discussion of the Background

Recently, users transmit and receive content, files, and data, such as photos, moving images, and music via a communication interface, such as an email, a social network service (SNS), a message, and the like. A user uses an application when transmitting and receiving content. Whenever data is attached, the data needs to be described or entered on a per application basis.

### SUMMARY

Exemplary embodiments of the present invention provide a method for displaying attribute information of data by using a processor.

Exemplary embodiments of the present invention also provide a content display apparatus.

Additional features of the invention will be set forth in the following description, and in part will be apparent from the description, or may be learned from practice of the invention.

An exemplary embodiment of the present invention discloses a method for displaying attribute information of data by using a processor. The method includes: receiving a request for the data; determining, using the processor, whether one or more pieces of attribute information are included in the data; processing a piece of attribute information if it is determined that at least one piece of attribute information is included in the data; and displaying the processed piece of attribute information.

An exemplary embodiment of the present invention also discloses a content display apparatus. The apparatus includes: a data request receiver to receive a request to receive data; an attribute information detector to detect one or more pieces of attribute information included in the data; an attribute information processor to process a piece of the detected attribute information; and a display unit to display the processed piece of attribute information.

An exemplary embodiment of the present invention further discloses a method for providing attribute information of data using a processor. The method includes: receiving a request for data, the data including a file directory (FD); determining, using the processor, whether one or more pieces of attribute information are included in the FD for selection; processing a piece of the attribute information included in the FD according to a characteristic of an application if it is determined that at least one piece of attribute information is included in the data; and displaying the processed piece of attribute information when the data is requested.

The foregoing general description and the following detailed description are only exemplary and explanatory and they are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating applications using content according to an exemplary embodiment of the present invention.

FIG. 2 is a diagram illustrating a content, file, or data attachment method according to an exemplary embodiment of the present invention.

FIG. 3 is a diagram illustrating a configuration of a display apparatus according to an exemplary embodiment of the present invention.

FIG. 4 is a diagram illustrating an attachment method for providing attribute information of content according to an exemplary embodiment of the present invention.

FIG. 5 is a flowchart illustrating a method for displaying content, data, or file according to an exemplary embodiment of the present invention.

FIG. 6 is a diagram illustrating the internal configuration of a header file according to an exemplary embodiment of the present invention.

FIG. 7 is a diagram illustrating characteristic information of an EXchangeable Image file Format Image file directory (EXIF IFD) according to an exemplary embodiment of the present invention.

FIG. 8 is a diagram illustrating characteristic information of Tag Embedded In MPEG I Layer III Files (ID3) of a moving picture experts group (MPEG)-1 or MPEG-2 Audio Layer III (MP3) file according to exemplary embodiments of the present invention.

FIG. 9 is a diagram illustrating attribute information corresponding to various application characteristics according to an exemplary embodiment of the present invention.

FIG. 10a is a diagram illustrating a display of attribute information to overlap content according to an exemplary embodiment of the present invention.

FIG. 10b is a diagram illustrating a display of attribute information to overlap content according to an exemplary embodiment of the present invention.

FIG. 10c is a diagram illustrating a display of attribute information to overlap content according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Prior to description of the exemplary embodiments of the present invention, the terms used in the present specification will be described. However, the descriptions provided herein are exemplary in nature and are not limited thereto. Content, data, or a file may refer to a variety of information, which may be provided via the Internet or computer communication, and/or a description thereof. Further, the content, data, or the file may also refer to a variety of information, which may be obtained by producing and/or processing at least one of characters, signs, sound, audio, video, moving images, and other forms of data using a digital method, or a description thereof. However, the type of format or the capacity of the content, data, or file is not limited thereto. In exemplary embodiments of the present invention, image information, sound information, and the like, without limitation, may be referred to or described as content. Image information may include data or files having various formats, including, without limitation, a bitmap image file (BMP), a joint photographic experts group file (JPG), a graphics interchange format file (GIF), an encapsulated postscript file (EPS), a tagged image file (TIF), a corel draw file (CDR), a photoshop data file (PSD), a Cubase compressed file (AL), a picture file (PIC), a paint shop pro file (PSP), a drawing exchange format file (DXF), a planetpress suite 3 file (PP3), a Macintosh picture image file (PICT), a portable network graphics file (PNG), and the like. Sound information may include files have various file formats, including, without limitation, a moving picture experts group (MPEG)-1 or MPEG-2 Audio Layer III (MP3), a waveform audio file format (WAV), a windows media audio (WMA), a transform-domain weighted interleave is vector quantization (VQF), an operation good guys (OGG), an audio codec 3 (AC3), a musical instrument digital interface (midi), a roshal archive (ra), a real audio movie (ram), an advance streaming redirector (asx), an audio (au), an audio interchange file format (aiff), and the like.

The term content display apparatus as used in the present specification will be described. The content display apparatus may be implemented in various forms and may include various features. The content display apparatus may refer to or include some or all apparatuses able to execute a specific application and the kind thereof is not limited. In an exemplary embodiment of the present invention, an application, such as a program or software, may be executed via the content display apparatus and may use a camera, a memory, computation capabilities, or other capabilities of the content display apparatus. For example, the content display apparatus may include, without limitation, handheld or mobile wireless terminals, such as a Personal Communication System (PCS) terminal, a Global System for Mobile communications (GSM) terminal, a Personal Digital Cellular (PDC) terminal, a Personal Handyphone System (PHS) terminal, a Personal Digital Assistant (PDA), and an International Mobile Telecommunication (IMT)-2000 terminal.

More particularly, the content display apparatus may be a smart phone or a mobile smart pad (e.g., iPad®, Galaxy®, and the like) including at least one of a display, various sensors, such as a touch sensor, a vibration motor, a speaker, a communication module, and the like.

In addition, the content display apparatus may include a processing system, which may include a processor, an operating system (OS), and an application program interface (API) and provide communication between one or more software applications and the OS. However, aspects of the invention are not limited thereto and exemplary embodiments of the present invention may be implemented by one or more combinations and configurations of operating systems, processors, software applications, and APIs.

The processing system of the content display apparatus may be configured to execute various software applications. The content display apparatus may communicate with another object and may include communication hardware or software installed therein.

Communication methods may include one or more communication methods for networking between objects. The communication method may include, without limitation, at least one of a wired communication, a wireless communication, a third generation (3G) mobile communication network, a fourth generation (4G) mobile communication, or other methods. Transmittable/receivable information may include variety of sensor information, voice feedback information, and vibration feedback information of the content display apparatus. Further, the transmittable/receivable information may be transmitted to an external object or received by an internal component.

A communication method may be performed by using, without limitation, at least one of a wireless Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi®, Voice over Internet Protocol (VoIP), Long Term Evolution (LTE) Advanced, IEEE802.16m, WirelessMAN-Advanced, Evolved High Speed Packet Access (HSPA+), 3^{rd} generation Partnership Project (3GPP), LTE, Mobile WiMAX (IEEE 802.16e), Ultra Mobile Broadband (UMB) (formerly EV-DO Rev. C), Flash-Orthogonal Frequency Division Multiplexing (OFDM), iBurst and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX).

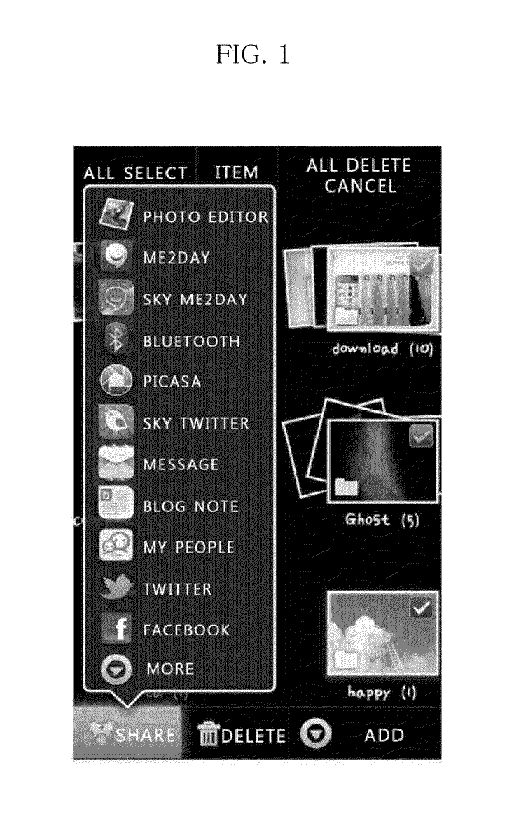

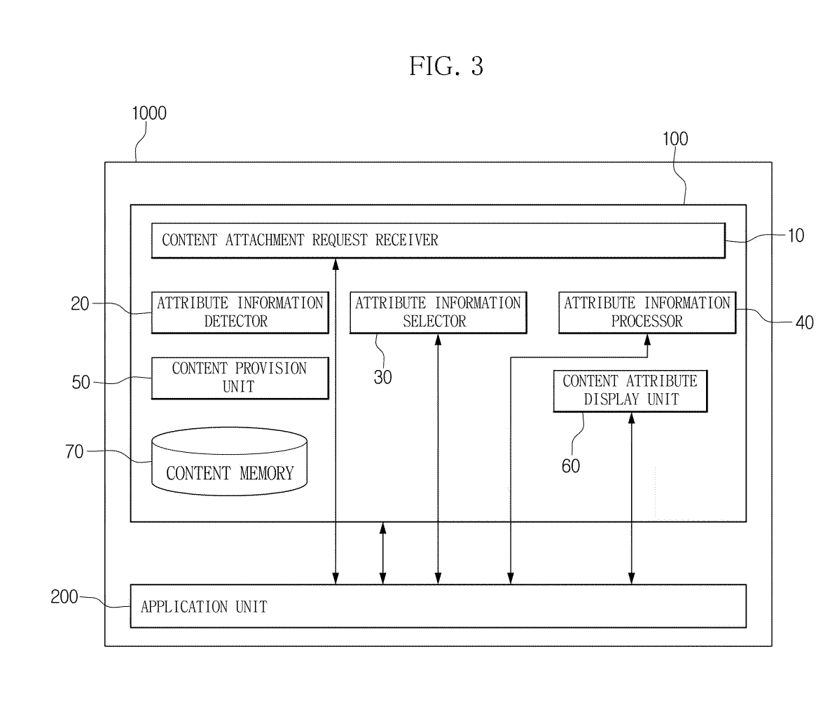

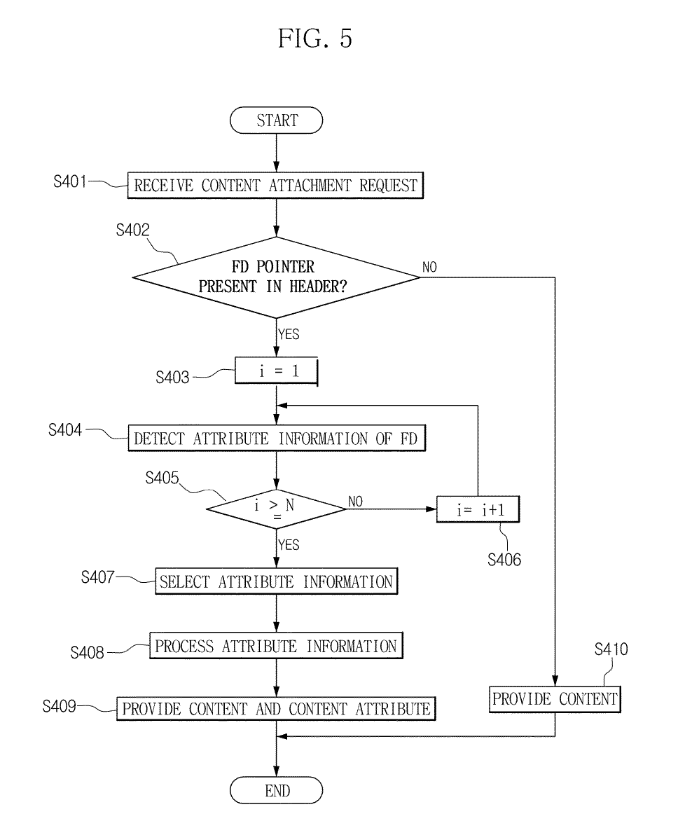

A configuration of the content display apparatus according to an exemplary embodiment of the present invention will be described with reference to FIG. 1, FIG. 3 and FIG. 5.

FIG. 3 is a diagram illustrating a configuration of a content display apparatus according to an exemplary embodiment of the present invention.

As shown in FIG. 3, the content display apparatus 1000 includes a content manager 100 and an application unit 200. The application unit 200 may refer to various application programs executed in the apparatus 1000. The application unit 200 may include one or more applications using content.

Referring to FIG. 1, a user may utilize a social network service (SNS), such as Facebook®, Twitter®, or Me2day® or a blog service, such as Micro Blog® or Tistory®. A user may utilize a variety of content via a menu interface to perform various operations, such as a sharing operation, a transmitting operation, or an attaching operation when such an application is used. These operations may be utilized to share, transmit, or attach a variety of contents.

The content manager 100 may serve to process and provide content and attribution information associated with the content. Attribution information associated with the content may be referred to as, without limitation, content attribution information. Further, the content manager 100 may reside in one or more devices to be applied to one or more applications. For example, the content manager 100 using an Android® operating system (OS) provided by Google® may reside on a device framework layer.

In the Android® OS, a variety of content may be provided by at least one of a broadcast intents action, a content resolver and a content provider.

However, the role and operation of the content manager 100 is not limited to a specific OS but may be applicable to various OSs included in various apparatuses. The content manager 100 and the application unit 200 may internally communicate with each other.

The content manager 100 includes a data request receiver 10, an attribute information detector 20, an attribution information selector 30, an attribute information processor 40, a data provision unit 50, a display unit 60 and a memory unit 70.

The data request receiver 10 may receive a content, data, or file request or an attachment request from a user. More specifically, the data request receiver 10 may receive the content, data, or file attachment request or request from the user via an interface provided by the application unit 200. However, aspects of the invention are not limited thereto, such that the data request receiver 10 may receive a content, data, or file request from at least one of an application, an external device, an internal device, a timer, a clock, a sensor device, and a voice feedback device.

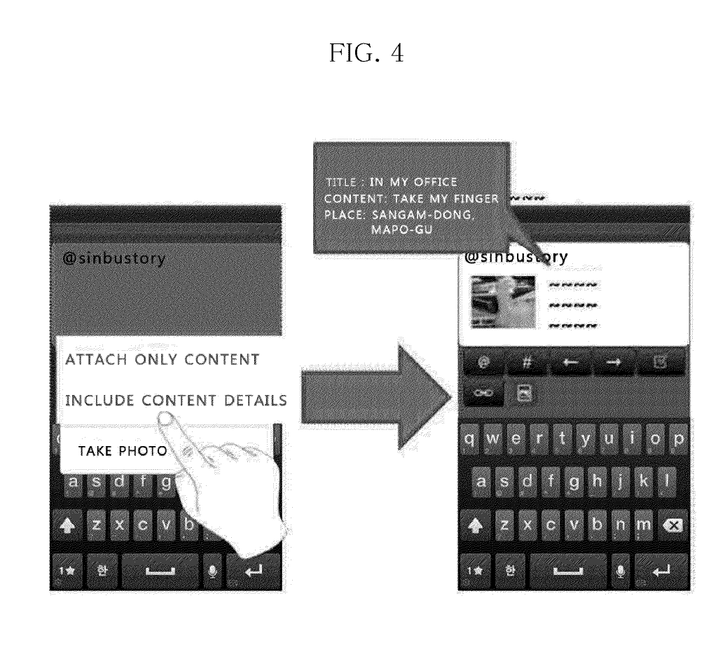

FIG. 4 shows a diagram illustrating an attachment method for providing attribute information of content according to an exemplary embodiment of the present invention.

As shown in FIG. 4, the content display apparatus 1000 may provide a menu associated with the content, which may be selected as an attachment or for sharing. Referring to FIG. 4, the user may select a menu item, such as “include description of content,” “include content details,” or “attach only content”, to request the content, data, or file. Further, the user may automatically request the content, data, or file by automatically including a description of the content, data, or file when the content, data, or file is attached without selecting a separate selection menu. For example, when a user selects a menu item, such as “take a photo” operation, the apparatus may take a photo and automatically attach the photo together with attribute information of the photo, such as a title, a place where the photo was taken (e.g. a GPS location), and the like.

The attribute information detector 20 may parse one or more file directories having or associated with the content, data, or file to be attached and/or to detect one or more pieces of attribute information. Parsing may refer to a process of reading and transforming a specific document or code into an external format used by another program or subroutine. More specifically, parsing may refer to a process of resolving or separating a series of strings into tokens and generating a parse tree composed of the tokens. Parsing may be performed by a parser and the attribute information detector 20 may be configured to perform parsing.

In addition, one or more file directories may be present and a plurality of pieces of attribute information may be present in a file directory. Attribute information may refer to characteristics or information associated with the content, data, or file. Attribute information may differ according to the format of the content, data, or file and may include various values, such as a title, an author, a comment, a keyword, a subject, a content capacity, a content storage path, a content creation date, and the like.

A space in a memory, which may be internal or external, including attribute information associated with the content, data, or file may be referred to as a file directory. Further, space in the memory or the file directory may be different according to a format of the respective content, data, or file, similarly to the attribute information.

For example, a tagged image file format (TIFF) file, which may be an image file, may include an EXchangeable Image file Format Image file directory (EXIF IFD), a Global Positioning System Image File Directory (GPS IFD), and the like as a file directory. An MP3 file, which may be a sound file, may include Tag Embedded In MPEG I Layer III Files (ID3), ID3v1, ID3v2 and other fields.

The attribute information selector 30 may select one or more pieces of attribute information. Further, the attribute information selector 30 may select attribute information regardless of the type and diversity of the application unit 200.

The type of attribute information associated with the content displayed via the interface of the application unit 200 may differ according to the type and one or more characteristics of the application unit 200. Content, data, or file may be differently displayed according to the application unit 200 to which the content, data, or file may be provided. Further, attribute information may be selected according to a request of the application unit 200 or the interface. For example, when an instant messenger service (IMS) is used, at least one of a content and title may be selected for use. When an email service is used, at least one of a content, email subject, and user comment may be selected for use. When an SNS, such as Facebook® is used, some or all information, such as a title, an author comment, an author, a keyword, a subject, and a content creation position may be selected for use. However, aspects of the invention are not limited thereto, such that the apparatus may display content and attribute information according to a user input, an attribute of a device transmitting or receiving the content, and the like.

The attribute information processor 40 may process attribute information according to the interface of the application unit 200. Referring to Table 1, if a simple tag description is attached to the parsed attribute information, a prefix and some of the attribute information may be combined according to the title attribute to provide the processed attribute information. A more detailed example thereof is shown in Table 1. With respect to the attribute “Title”, attribute information, “smart plus”, may be processed to recite “photo title: at smart plus”. In addition, attribute information may be processed to be combined to provide the respective information in a sentence format. For example, the attribute information included in Table 1 may be combined to recite, “at the smart plus, Chul-Soo KIM has opened a phone and has taken a photo associated with the telephone”. Attribute information may be combined with other words placed towards the end of the attribute information to form sentences.

Further, the processing of attribute information may include combining in various manners one or more pieces of attribute information with information provided by the application or the interface. Attribute information including at least one of a text, characters, images, sounds, vibrations, videos, and the like may be combined with information provided by the application or interface. The combinations and manner of combining between the attribute information and the elements provided by the application or interface are not limited thereto. The processing of attribute information may also include a deletion of a portion of the attribution information, such as data, text, or characters included in the attribute information.

The processing of the attribute information is exemplary and the attribute information may be processed differently according to at least one of an application usage, an interface, a user customization, and a user input.

TABLE 1

| Attribute | Before processing | After processing |
|---|---|---|
| Title | At smart plus | Photo title: at smart plus |
| Comment | Since my new phone has | Photo description: Since my new |
| | opened, I feel good. | phone has opened, I feel good. |
| Author | Chul-Soo KIM | Photographer: Chul-Soo KIM |
| Keyword | Open, phone | Open, phone |
| Subject | Smart phone Opening | Photo subject: Smart phone |
| | | Opening |

The data provision unit 50 may attach or provide the content, data, or file. Further, the attachment or the providing of the content, data, or file may be displayed in the form of a preview. The content, data, or file may be provisioned in various ways and there may be no restriction in the provision method.

The display unit 60 may provide or display the selected attribute information. Further, the display unit 60 may display the attribute information according to the interface of the application unit 200. More specifically, the attribute information may be displayed with respect to the application unit 200. Similarly to the attribute information selector 30, when an IMS is used, the content, data, or file may be attached to a chat window and a content title may be automatically and/or preliminarily displayed in a message. When an email service is used, the content, data, or file may be attached as a file to be sent, a content title may be displayed in a subject line, and a user comment or message may be displayed in a writing column. In addition, when an SNS, such as Facebook®, is used, information, such as a content title, an author comment, an author, a keyword, a subject, and a content creation position or location may be displayed.

The processed attribute information may be displayed or provided together with the content according to an interface, an application, a reference condition, a user input, input from internal or external devices, such as a timer, a light sensor, a temperature sensor, a vibration sensor, and various events.

The memory unit 70 may store at least one of content, a content file directory, attribute information, and the like. One or more file directories may be present and a plurality of pieces of attribute information may be present in a file directory. Attribute information may indicate or refer to characteristics of the content, data, or file and may differ according to the format of the content. Attribute information may include, without limitation, at least one of content, a title, a content author, a comment, a keyword, a subject, a content capacity, a content storage path, a content creation date, and the like.

Although not shown, a content attribute editor to edit the attribute information of the content, data, or file may be included in the content display apparatus 1000. Attribute information, such as GPS information or time information, may be automatically or manually created when creating content. Further, attribute information, such as title information, and/or keywords may be added, deleted or changed according to a user preference or reference condition of an application even after the content is created. For example, information about a place may be automatically input via GPS information when taking a photo, and a title and a description may be separately input via an editing operation when or after taking a photo. However, aspects of the invention are not limited thereto, such that the attribute information may be changed according to a reference condition of an application, an interface, a system specification of a transmitting device or a receiving device, and the like. Attribute information may be edited in various methods and there may be no restriction in a content attribute editing method.

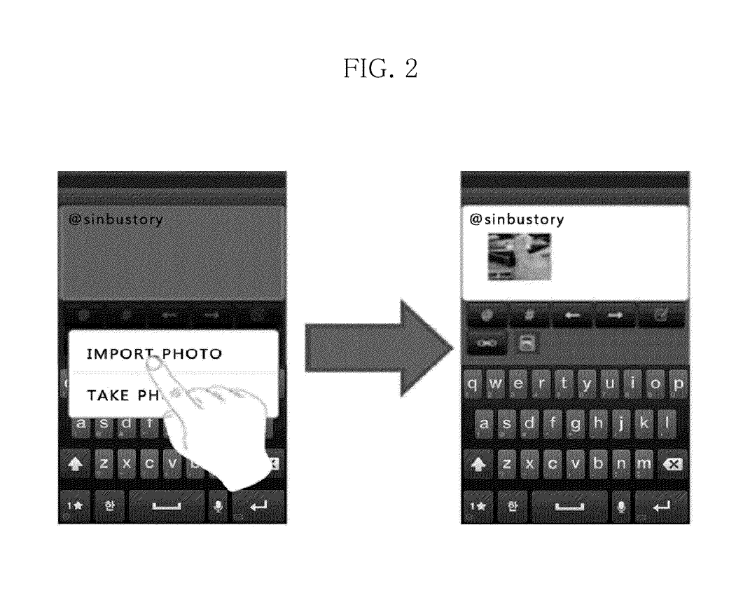

FIG. 2 is a diagram illustrating a content attachment method according to an exemplary embodiment of the present invention. FIG. 4 is a diagram illustrating an attachment method for providing attribute information of content according to an exemplary embodiment of the present invention.

When comparing FIG. 4 with FIG. 2, FIG. 2 shows a method of attaching an image without special manipulation. Referring to FIG. 2, two selection options are provided, 1) “import a photo,” option and 2) “take a photo” option. Here, content may not be processed although the two selection elements are different in that, one selection element or option 1 imports the content, data, or file, and the other selection element or potion 2 creates a content, data, or file in real time.

Referring to FIG. 4, the content display apparatus 1000 provides two options including 1) “attach only content” option and 2) “include a content description” option. However, aspects of the invention are limited thereto, such that additional options may be provided.

Although the present disclosure may refer primarily to option 2 (i.e. “include a content description” option), option 1 (i.e. “attach only content” option) may be provided to transmit and display content without special information preferences.

Referring again to FIG. 4, if the option 2) (i.e., “include a content description” option) is selected, a photo as the content, data, or file along with attribute information stored in the content or data, such as a title, a description, and a place associated with the photo may be automatically provided, as shown on an image illustrated on the right side of FIG. 4. Thus, attribution information associated with the content, data, or file may be provided without a user having to directly input such information, which may include at least one of a title, a description, a place, and the like. Accordingly, even if the user does not remember the attribute information associated with content, the associated attribute information may be automatically inputted. Content attribute information or attribute information associated with content may be automatically generated or may be inputted by a user when creating the content. Further, content attribute information may be deleted, changed or added according to user's direction or according to reference criteria even after content is created.

For example, if the content attribute information is associated with a “place”, GPS information may be automatically inputted when taking a photo. If the content attribute information is associated with a “title” or a “description” of a particular content, data, or file, the attribute information may be obtained through an external server or the user may input the respective information through an editing operation during or after taking a photo.

Exemplary embodiments of a content display method will be described in more detail below.

FIG. 5 shows a flowchart illustrating a method for displaying content according to an exemplary embodiment of the present invention.

As shown in FIG. 5, in operation S401, the content display apparatus 1000 receives a content, data, or file attachment request or request through user input. The content, data, or file attachment request or request may be provided when a user selects a menu, such as share or attachment. Further, when the content, data, or file is attached, a content description may be automatically attached or provided.

In operation S402, a determination as to whether a file directory (FD) pointer is present in a header file of the content, data, or file is made. If the FD pointer is determined to be present in the header file, the method proceeds to operation S403 for initializing a parameter “i” to have a value of 1. However, aspects of the invention are not limited thereto, such that the parameter “i” may have a different initialization value. If the FD pointer is determined not to be present in the header file, the method proceeds to operation S410 to provide the content. The FD may refer to a separate space in a memory of the content display apparatus 1000 in which the attribute information of the content, data, or file is stored. Although a single FD pointer may be described, aspects of the invention are not limited thereto, such that a plurality of FD pointers may be present.

The FD pointer may indicate a physical address of the FD and may also be referred to as a data offset. The FD pointer value may be a reference value representing the position of the FD.

Since a plurality of pieces of attribute information may be present in one FD, a parameter “i” may be set and initialized for the purpose of generating a routine for detecting a number (N) of pieces of attribute information.

In operation S404, the attribute information of the FD is detected. In operation S405, a comparison between the parameter “i” and the N number of pieces of attribute information is made. More specifically, a determination is made to determine if the parameter “i” is greater than or equal to the N number pieces of attribute information. If the parameter “i” is determined to be less than N number of attribute information, the parameter “i” is increased by 1 in operation 5406 and the method proceeds back to operation 5404 to repeat operation 5404 and operation 5405. These operations may be repeated until the parameter “i” becomes greater than or equal to N number of attribute information. The attribute information may be detected through parsing, but is not limited thereto. Further, although parameter “i” is increased by 1 in operation 5406, aspects of the invention are not limited thereto, such that the parameter “i” may to be increased by a different number.

In operation 5407, one or more of the detected pieces of attribute information are selected. The attribute information may be selected using different methods according to applications to utilize attribute information with respect to each application. In operation 5408, the attribute information is processed according to one or more characteristics of the application. In operation 5409, the processed attribute information is provided along with content.

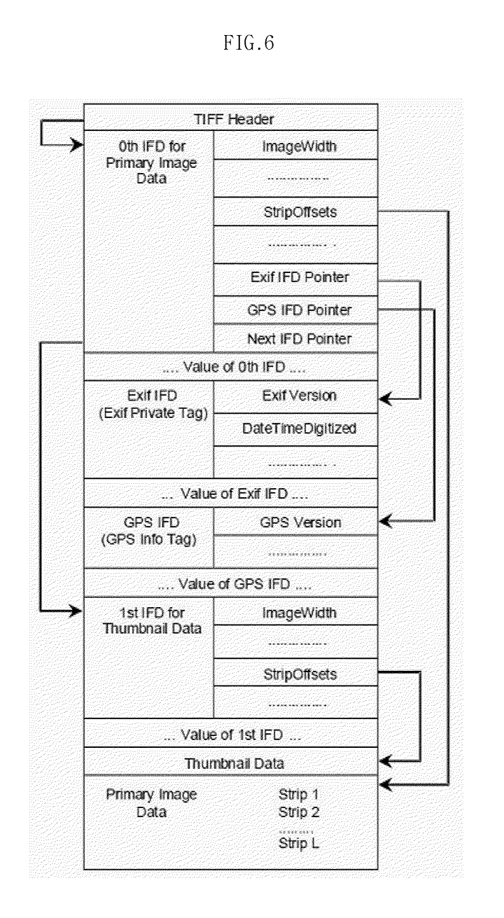

For example, the processing of a TIFF file will now be described with reference to FIG. 6. FIG. 6 shows a diagram illustrating the internal configuration of a header file according to an exemplary embodiment of the present invention.

As shown in FIG. 6, a header file, such as a TIFF header file, includes an image width or an image height (not shown), a Strip Offset, an EXIF IFD pointer, a GPS IFD pointer, and Next IFD pointer. The EXIF IFD pointer and the GPS IFD pointer may point to positions of an EXIF IFD and a GPS IFD, which may be file directories.

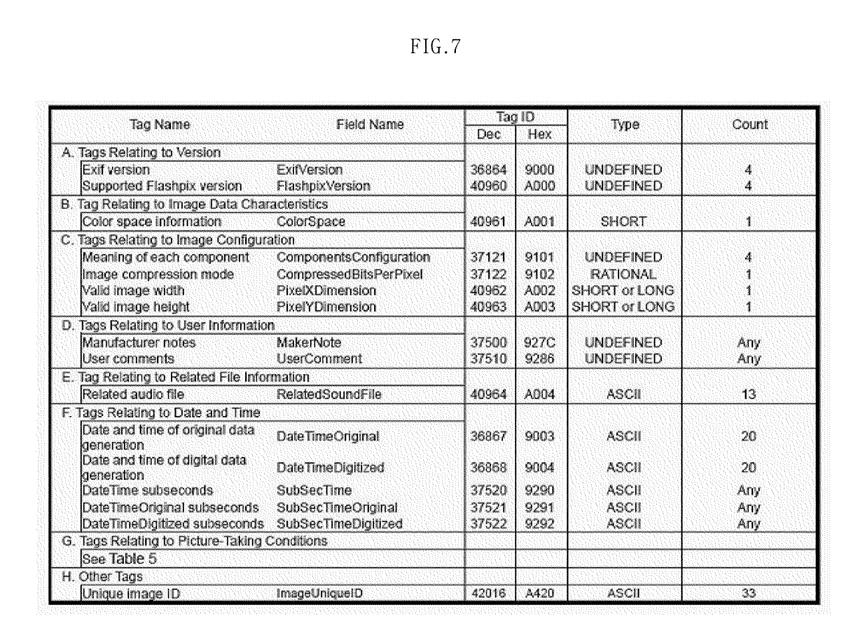

The EXIF IFD will now be described in more detail with reference to FIG. 7. FIG. 7 shows a diagram illustrating characteristic information of an EXIF IFD according to an exemplary embodiment of the present invention.

As shown in FIG. 7, the EXIF IFD includes characteristic information, such as a tag name, a field name, a tag ID, a data type, and a count. The tag name column lists A. tags relating to version, B. tags related to image data characteristics, C. tags relating to image configuration, D. tags relating to user information, E. tags relating to related file information, F. tags relating to date and time, G. tags relating to picture taking conditions, and H. other tags. For each tag name, FIG. 7 shows corresponding information associated to these tags such as a field name, a tag ID, a data type, and a count. In the EXIF IFD, detailed information of the image is recorded. More specifically, attribution information, such as a user comment, a date and time of original data generation, a unique image ID and/or a presence/absence of a flash is recorded. Further, attribute information selected or targeted by a user may be further recorded and stored in the EXIF IFD. The attribute information may be read according to a user request or a reference condition and may be processed according to an application to which the attribute information is to be provided.

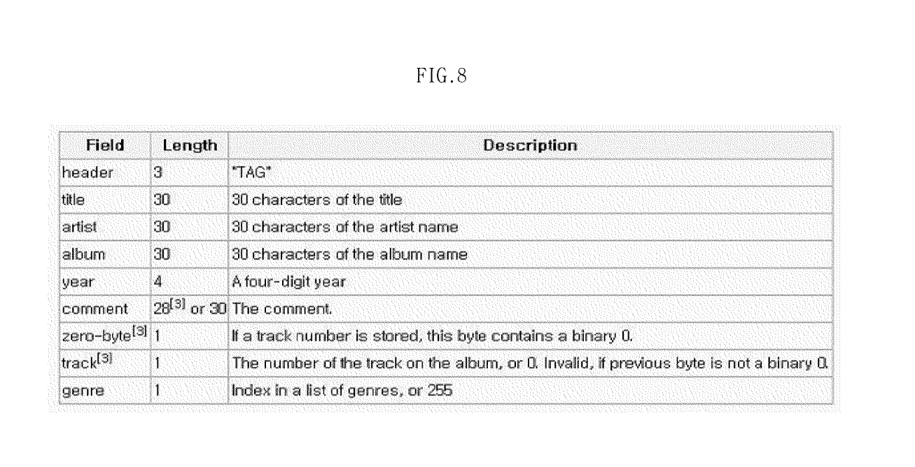

FIG. 8 is a diagram illustrating characteristic information of ID3 of an MP3 file according to exemplary embodiments of the present invention.

As shown in FIG. 8, an MP3 file may include characteristic information of ID3v1, which includes a field column, a length column, and a description column. The characteristics information of ID3v1, under the field column, lists a header, a title, an artist, an album, a year, a user comment, a track and a genre.

Since the file directory is configured in a code format including attribute information, attribute information may be extracted through parsing. The attribute information detector 20 may detect one or more pieces of attribute information of one or more file directories.

According to exemplary embodiments of the present invention, the attribute information detector 20 may parse one or more file directories pointed by a file directory pointer if the file directory pointer is included in a header file of a content, data, or file to be attached. A header file may be included in the content, data, or file. The header file may refer to data located at a foremost side of a data block of the content, data, or file, and may include bibliographic data of the content, data, or file. The header file may include a file directory pointer, and the file directory pointer may point or direct to a physical space of a file directory.

A method for displaying the selected attribute information in the content display apparatus according to an exemplary embodiment of the present invention will be briefly described.

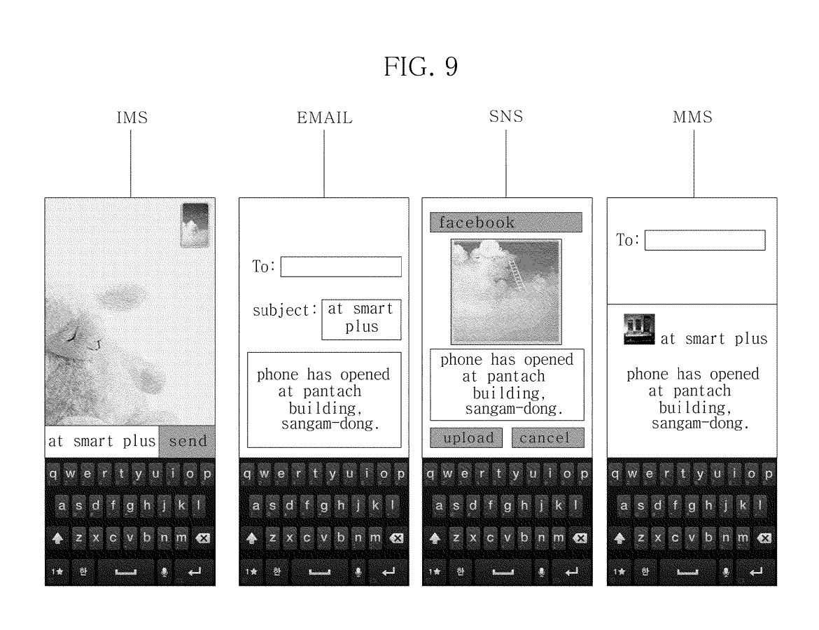

FIG. 9 shows a diagram illustrating attribute information corresponding to various application characteristics according to an exemplary embodiment of the present invention.

As shown in FIG. 9, a display unit displays attribute information according to an interface displayed or provided on an application unit. More specifically, the attribute information is displayed with respect to the application unit. Further, the attribute information may be displayed to be specifically tailored to the application unit or the interface. For example, when an IMS is used, content or data may be attached to a chat window and a title of a content, data, or file may be automatically and/or preliminarily displayed in a text message. Further, when an email service is used, a content, data, or file may be attached as an attachment file, a content title may be displayed in a subject line, and a user comment may be displayed in a writing column. In addition, when an SNS, such as Facebook® is used, content and a user comment may be displayed as an upload object and when a Multimedia Messaging Service (MMS) is used, content and a content title may be displayed in a chat window.

Further, attribute information may be displayed next to or below the content, data, or file, however, locations of the attribute information is not limited thereto. Further, attribute information may be displayed to overlap content by the content attribute display unit.

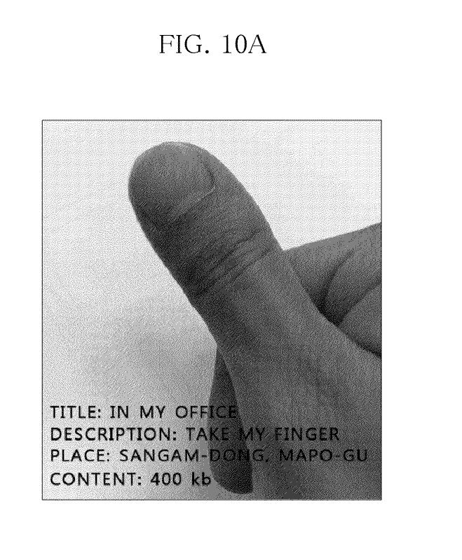

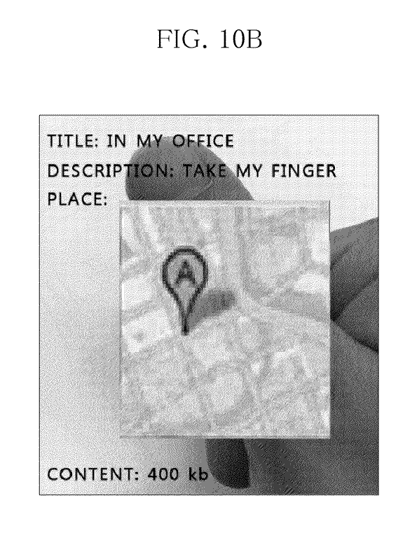

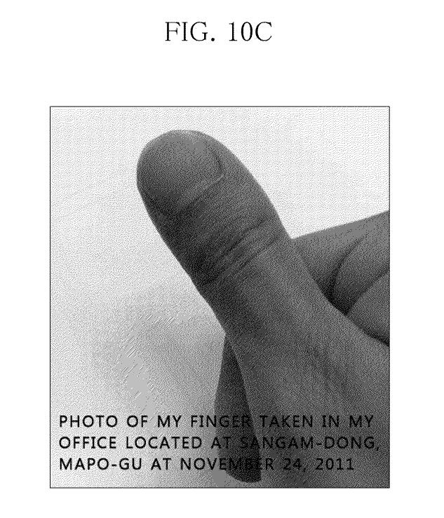

FIG. 10a, FIG. 10b, and FIG. 10c are diagrams illustrating displays of attribute information to overlap content, data, or file according to exemplary embodiments of the present invention. As shown in FIG. 10a, text describing a title, a description of the content, a place where the photo was taken, and a size of the content are displayed to overlap the content, which is a picture of a right thumb.

As shown in FIG. 10b, regional information using GPS information may be processed via a map application and may be displayed to overlap content. If the image of the displayed map application is clicked, the map application may be executed. In FIG. 10c, attribute information may be processed to a sentence form using time and place information and may be displayed to overlap content. However, aspects of the present invention are not limited thereto, such that the attribute information may be processed to a sentence form using other attribute information.

According to exemplary embodiments of the present invention, attribute information associated with a content, data, or file may be automatically utilized when the content, data, or file is attached or provided. Accordingly, since the same description may not be repeatedly written in a plurality of applications, user convenience may be improved.

Since attribute information associated with the content, data, or file, which may be inputted by a user or automatically provided, may be processed and provided when the content, data, or file is used, it may be possible to provide the processed attribute information associated with the content, data, or file to the user regardless of when content is used.

Further, since attribute information stored in the content may be automatically selected and processed according to one or more characteristics of an application, it may be possible to provide tailored attribute information to one or more applications.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for displaying attribute information of data using a processor, the method comprising:
receiving a request for the data;
determining, using the processor, whether one or more pieces of attribute information are included in the data;
processing a piece of attribute information if it is determined that at least one piece of attribute information is included in the data; and
displaying the processed piece of attribute information;
wherein the piece of attribute information is processed according to a characteristic of an application.

2. The method of claim 1, further comprising:
determining whether a file directory (FD) pointer is included in the data,
wherein the FD pointer indicates a physical address of the FD and the FD includes one or more pieces of attribute information.

3. The method of claim 1, further comprising:
editing the piece of attribute information according to an input.

4. The method of claim 1, further comprising:
initializing a parameter for determining a count;
determining a number of pieces of attribute information included in the data;
comparing a value of the parameter against the number of pieces of attribute information; and
increasing the value of the parameter until the value of the parameter is at least equal to the number of pieces of attribute information.

5. The method of claim 1, further comprising:
storing the processed piece of attribute information.

6. The method of claim 5, further comprising:
automatically providing the stored piece of attribute information when an application requests the data.

7. The method of claim 1, further comprising:
parsing the data to detect one or more pieces of attribute information.

8. The method of claim 1, wherein attribute information comprises at least one of location information, a title, an author, a comment, a keyword, a subject, a content capacity, a content storage path, a content creation date, and a content creation time.

9. The method of claim 1, wherein the processing of the piece of attribute information comprises:
combining the piece of attribute information with information provided by at least one of an application and an interface.

10. The method of claim 1, wherein the piece of attribute information is processed to be combined to provide content information in a sentence format.

11. The method of claim 1, further comprising:
automatically generating attribute information associated with the data when creating the data.

12. A content display apparatus, comprising:
a data request receiver to receive a request to receive data;
an attribute information detector to detect one or more pieces of attribute information included in the data;
an attribute information processor to process a piece of the detected attribute information; and
a display unit to display the processed piece of attribute information;
wherein the piece of attribute information is processed according to a characteristic of an application.

13. The content display apparatus of claim 12, further comprising:
an application unit comprising one or more applications that are capable of using the data.

14. The content display apparatus of claim 12, wherein the attribute information detector parses the data to detect the one or more pieces of attribute information.

15. The content display apparatus of claim 12, further comprising:
a memory unit to store the processed piece of attribute information.

16. The content display apparatus of claim 15, further comprising:
a data provision unit,
wherein the data provision unit automatically retrieves the stored piece of attribute information when an application requests the data.

17. The content display apparatus of claim 12, further comprising:
an attribute editor for editing the piece of attribute information according to an input.

18. The content display apparatus of claim 12, wherein the data comprises a file directory (FD), the file directory including one or more pieces of attribute information.

19. The content display apparatus of claim 12, wherein the attribute information processor combines the piece of attribute information with information provided by at least one of the application and an interface.

20. A method for providing attribute information of data using a processor, the method comprising;
receiving a request for data, the data comprising a file directory (FD);
determining, using the processor, whether one or more pieces of attribute information are included in the FD for selection;
processing a piece of the attribute information included in the FD according to a characteristic of an application if it is determined that at least one piece of attribute information is included in the data; and
displaying the processed piece of attribute information when the data is requested.
